(19) United States
(12) Patent Application Publication
(10) Pub. No.: US 2025/0284015 A1
(43) Pub. Date: Sep. 11, 2025

(54) DATA-DRIVEN DEPTH UNCERTAINTY ESTIMATION USING SEISMIC VELOCITY AND ANISOTROPY TRADEOFFS

(71) Applicant: CHEVRON U.S.A. INC., San Ramon, CA (US)

(72) Inventors: Jinsong Chen, Fulshear, TX (US); Sizhuang Deng, Houston, TX (US); Min Yang, Houston, TX (US); Andrey Shabelansky, Bellaire, TX (US); Cory Hoelting, Houston, TX (US); Huafeng Liu, Bellaire, TX (US); Maisha Lara Amaru, Houston, TX (US)

(21) Appl. No.: 18/600,337

(22) Filed: Mar. 8, 2024

(51) Int. Cl. G01V 1/28; G01V 1/30

(52) U.S. Cl. CPC G01V 1/282; G01V 1/301; G01V 2210/614; G01V 2210/6222; G01V 2210/626

(57) ABSTRACT

Systems and methods are provided for subsurface characterization from seismic data. The system can receive a plurality of candidate velocity and anisotropic parameter models and seismic gather data. A subset of the plurality of candidate velocity and anisotropic parameter models can be selected to form a training data set. The system can generate a joint probability functions of depth differences and seismic semblances based on the training data set and generate a likelihood function based on the joint probability function. A Bayesian model can be defined using the likelihood function and the prior probability functions. The system can draw a plurality of samples from a posterior distribution of the Bayesian model using Markov Chain Monte Carlo sampling methods and calculate depth uncertainty values using the plurality of samples.

### TECHNICAL FIELD

The present disclosure relates generally to hydrocarbon production, and in particular, some implementations may relate to characterizing subsurface features to estimate hydrocarbon production.

### DESCRIPTION OF RELATED ART

Subsurface depth uncertainty estimation plays an important role in the risk mitigation of hydrocarbon production and CO₂ storage. Depth uncertainty refers to any uncertainty in the target depths of subsurface features when detected using seismic data. Depth uncertainty, if ignored, can result in costly mistakes associated with well planning and drilling. Due to uncertainties of anisotropic seismic velocity, depth uncertainty can be estimated either during or after the estimation of the velocity of seismic data during a survey. Anisotropic seismic velocity refers to the velocity of seismic waves in a medium within the Earth. Due to the complexity of geological structures, and the limitations of seismic data, it can be challenging to fully determine depth uncertainty.

### BRIEF SUMMARY OF THE DISCLOSURE

According to various embodiments of the disclosed technology, a computer-implemented method for subsurface characterization from seismic data can comprise receiving a plurality of candidate velocity and anisotropic parameter models and seismic gather data. A subset of the plurality of candidate velocity and anisotropic parameter models can be selected to form a training data set. The training set can be used to generate a joint probability function of depth differences and seismic semblances. A likelihood function can be generated based on the joint probability function. The probability density function can be a joint probability density function of depth differences and semblances or marginal probability distribution of depth differences. These probability density functions together can be used to define a Bayesian model. This Bayesian model can be used to estimate depth uncertainties. The system can draw many samples from the posterior probability distribution of the Bayesian model. These samples may be used to calculate the 10^{th} quantile (i.e., P10) and the 90^{th} quantile (i.e., P90) values for depth uncertainty. Depth uncertainty values can be displayed and/or stored. In some embodiments, generating the probability density functions can include creating a plurality of candidate perturbed models from the reference model that were derived from seismic data.

In some embodiments, selecting the subset of the plurality of candidate velocity and anisotropic parameter models comprises calculating residual normal moveout. A window size can be set based on the residual normal moveout, and the system can specify a cutoff value based on the residual normal moveout and the window size.

In some embodiments, the seismic gather related data includes semblances, a number of rays, and a minimal and maximal variance for calculating semblances. If the total number of valid rays is less than a preset number (e.g., five), it is treated as missing or less reliable data. Geostatistical or other spatial interpolation methods are used to estimate semblance value at that location. The candidate models can include 2-D or 3-D representation of the subsurface that includes information about the seismic velocity (P-wave velocity and/or S-wave velocity) and, optionally, the anisotropic parameters (η and δ) at each location. A plurality of candidate perturbed models may be created from the reference model by random perturbation flowing various different methods. A subset of this plurality may be selected as trial models. The depth differences and semblance values for each trial model may be calculated to form a set of depth differences and a set of semblance values. These two sets form a learning data set and may be combined to derive a joint probability density function of depth differences and semblances, and marginal probability distribution of depth differences.

In some embodiments, generating the joint probability function of depth differences and seismic semblances comprises employing Kernal density estimation. In some embodiments, the method includes fitting the depth differences and semblance values using kernel density estimation or other data-driven algorithms to estimate the joint probability density function.

In some embodiments, the joint probability functions of depth differences are based on a difference between true depth (zₜᵣᵤₑ) and reference depth (z_{ref}). In some embodiments, the depth differences may be calculated as H={z(mᵢ)−z_{ref}:i∈N}, where z_{ref} is a depth to a target surface calculated from a reference velocity model, z(mᵢ) is a depth to the target surface calculated from a trial model mᵢ, and i is an index indicating each trial model of the subset.

In some embodiments, the subset may be selected based on a plurality of automatic criteria. In some embodiments, these criteria may include detectability or a preset residual normal moveout ratio. This subset can consider local variability of residual normal moveouts to allow for a larger total number of trial models. In some embodiments, the samples are obtained using Markov Chain Monte Carlo (MCMC) sampling, which is an effective technique to draw samples from complex joint probability distribution.

In some embodiments, the method further includes generating a graphical representation of the depth uncertainty model based on corresponding depth. This graphical representation can be displayed on a user interface in various ways, including with a heat map, graph, bar chart, or other representation. Based on this display, the system can characterize a subsurface area of interest.

According to various embodiments of the disclosed technology, a system for subsurface characterization from seismic data includes a processor; a display; and a memory encoded with instructions. These instructions, when executed by the processor, can cause the processor to receive a plurality of candidate velocity and anisotropic parameter models and seismic gather data. A subset of the plurality of candidate velocity and anisotropic parameter models can be selected to form a training data set. The training set can be used to generate a joint probability function of depth differences and seismic semblances. A likelihood function can be generated based on the joint probability function. The probability density function can be a joint probability density function of depth differences and semblances or marginal probability distribution of depth differences. These probability density functions together can be used to define a Bayesian model. This Bayesian model can be used to estimate depth uncertainties. The system can draw many samples from the posterior probability distribution of the Bayesian model. These samples may be used to calculate the 10^{th} quantile (i.e., P10) and the 90^{th} quantile (i.e., P90) values for depth uncertainty. Depth uncertainty values can be displayed and/or stored. In some embodiments, generating the probability density functions can include creating a plurality of candidate perturbed models from the reference model that were derived from seismic data. The system can generate a graphical representation of the depth uncertainty model based on corresponding depth. This graphical representation can be displayed on a user interface in various ways, including with a heat map, graph, bar chart, or other representation. Based on this display, the system can characterize a subsurface area of interest.

In some embodiments, selecting the subset of the plurality of candidate velocity and anisotropic parameter models comprises calculating residual normal moveout. A window size can be set based on the residual normal moveout, and the system can specify a cutoff value based on the residual normal moveout and the window size.

In some embodiments, the seismic gather related data includes semblances, a number of rays, and a minimal and maximal variance for calculating semblances. The candidate models can include 2-D or 3-D representation of the subsurface that includes information about the seismic velocity (P-wave velocity and/or S-wave velocity) and, optionally, the anisotropic parameters (η and δ) at each location. A plurality of candidate perturbed models may be created from the reference model by random perturbation flowing various different methods. A subset of this plurality may be selected as trial models. The depth differences and semblance values for each trial model may be calculated to form a set of depth differences and a set of semblance values. These two sets form a learning data set and may be combined to derive a joint probability density function of depth differences and semblances, and marginal probability distribution of depth differences.

In some embodiments, generating the joint probability function of depth differences and seismic semblances comprises employing Kernal density estimation. In some embodiments, the method includes fitting the depth differences and semblance values using kernel density estimation or other data-driven algorithms to estimate the joint probability density function.

In some embodiments, the joint probability functions of depth differences are based on a difference between true depth (zₜᵣᵤₑ) and reference depth (z_{ref}). In some embodiments, the depth differences may be calculated as H={z(mᵢ)−z_{ref}:i∈N}, where z_{ref} is a depth to a target surface calculated from a reference velocity model, z(mᵢ) is a depth to the target surface calculated from a trial model mᵢ, and i is an index indicating each trial model of the subset.

In some embodiments, the subset may be selected based on a plurality of automatic criteria. In some embodiments, these criteria may include detectability or a preset residual normal moveout ratio. This subset can consider local variability of residual normal moveouts to allow for a larger total number of trial models. In some embodiments, the samples are obtained using Markov Chain Monte Carlo (MCMC) sampling, which is an effective technique to draw samples from complex joint probability distribution.

According to various embodiments of the disclosed technology, a non-transitory machine-readable storage medium can be encoded with instructions. These instructions, when executed by a processor, can cause the processor to receive a plurality of candidate velocity and anisotropic parameter models and seismic gather data. A subset of the plurality of candidate velocity and anisotropic parameter models can be selected to form a training data set. The training set can be used to generate a joint probability functions of depth differences and seismic semblances. A likelihood function can be generated based on the joint probability function. The probability density function can be a joint probability density function of depth differences and semblances or marginal probability distribution of depth differences. These probability density functions together can be used to define a Bayesian model. This Bayesian model can be used to estimate depth uncertainties. The system can draw many samples from the posterior probability distribution of the Bayesian model. These samples may be used to calculate the 10^{th} quantile (i.e., P10) and the 90^{th} quantile (i.e., P90) values for depth uncertainty. Depth uncertainty values can be displayed and/or stored. In some embodiments, generating the probability density functions can include creating a plurality of candidate perturbed models from the reference model that were derived from seismic data. The system can generate a graphical representation of the depth uncertainty model based on corresponding depth. This graphical representation can be displayed on a user interface in various ways, including with a heat map, graph, bar chart, or other representation. Based on this display, the system can characterize a subsurface area of interest.

In some embodiments, selecting the subset of the plurality of candidate velocity and anisotropic parameter models comprises calculating residual normal moveout. A window size can be set based on the residual normal moveout, and the system can specify a cutoff value based on the residual normal moveout and the window size.

In some embodiments, the seismic gather related data includes semblances, numbers of rays, and minimal and maximal variance for calculating semblances. The candidate models can include 2-D or 3-D representation of the subsurface that includes information about the seismic velocity (P-wave velocity and/or S-wave velocity) and, optionally, the anisotropic parameters (η and δ) at each location. A plurality of candidate perturbed models may be created from the reference model by random perturbation flowing various different methods. A subset of this plurality may be selected as trial models. The depth differences and semblance values for each trial model may be calculated to form a set of depth differences and a set of semblance values. These two sets form a learning data set and may be combined to derive a joint probability density function of depth differences and semblances, and marginal probability distribution of depth differences.

In some embodiments, generating the joint probability function of depth differences and seismic semblances comprises employing Kernal density estimation. In some embodiments, the method includes fitting the depth differences and semblance values using kernel density estimation or other data-driven algorithms to estimate the joint probability density function.

In some embodiments, the joint probability functions of depth differences are based on a difference between true depth (zₜᵣᵤₑ) and reference depth (z_{ref}). In some embodiments, the depth differences may be calculated as H={z(mᵢ)−z_{ref}:i∈N}, where z_{ref} is a depth to a target surface calculated from a reference velocity model, z(mᵢ) is a depth to the target surface calculated from a trial model mᵢ, and i is an index indicating each trial model of the subset.

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein, which are defined solely by the claims attached hereto.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The present disclosure, in accordance with one or more various embodiments, is described in detail with reference to the following figures. The figures are provided for purposes of illustration only and merely depict typical or example embodiments.

FIG. 1 illustrates an example system in accordance with the embodiments described herein.

FIGS. 2A-2B illustrate graphical representations of the Bayesian model as applied to a target surface, in accordance with one embodiment.

FIGS. 3A-3B illustrates example displays representing depth uncertainty estimation in a subsurface medium, in accordance with the systems and methods described herein.

FIG. 4 illustrates an example method in accordance with the embodiments described herein.

FIG. 5 is an example computing component that may be used to implement various features of embodiments described in the present disclosure.

The figures are not exhaustive and do not limit the present disclosure to the precise form disclosed.

### DETAILED DESCRIPTION

Traditional systems can apply data to estimate depth uncertainty in various ways. Some systems apply Monte Carlo methods to generate an ensemble of models based on a given reference model (including seismic velocity and anisotropic parameters) by perturbation. Here, Monte Carlo methods refer to the use of simulated random numbers to estimate some functions of a probability distribution. The probability distributions may be generated by estimating the expected value by the use of a simulated sample from the distribution of random variables. These functions apply one dimensional physics by flattening the seismic traces obtained in a survey. These functions may be used to determine depth uncertainty at each location. While this method is effective under certain conditions, it does not consider lateral continuity and considerations in three dimensions (3D). Accordingly, the resulting derived uncertainty bounds can be very wide. Other systems apply 3D stochastic methods to generate velocity and anisotropy parameters in a vertical transverse isotropy (VTI) medium. These systems apply normal moveout (NMO) travel time and detectability criteria to guide model generations. These models can be trained with 3D seismic data to reduce depth uncertainty. The trained models work well when subsurface structures are relatively simple, and the generated models follow the designed probability distributions. However, in practice, many subsurface geological structures are complex, and reference models may be subject to unknown biases and interpretation uncertainties. These complexities can reduce the visual and calculated quality of the models.

Embodiments of the systems and methods disclosed herein apply a data-driven Bayesian model to provide robust estimates of depth uncertainty. The Bayesian model can provide more accurate and robust results when subsurface geological structures are complex (i.e., due to subsalt or faults). This Bayesian model can produce depth uncertainty estimates with faster computation times and higher accuracy compared to traditional systems. Additionally, the systems and embodiments described herein are directed to an improved user interface for displaying and interacting with depth uncertainty estimations as provided above. As described above, traditional representations and displays may not be as accurate in situations where the subsurface features are complex. The technology described herein includes methods of displaying more accurate depth uncertainty information to the user, rather than using conventional user interface methods to generically display a rough estimate depth uncertainty. These systems recite a specific improvement over conventional systems, including an improved user interface for use in hydrocarbon production.

These systems and embodiments improve the efficiency of hydrocarbon production by providing a more accurate representation of depth uncertainty in a subsurface area of interest. This improved display allows for the presentation and consumption of information in a unique and necessary manner that enables personnel to immediately have the information they need accurately and quickly identify desired or target hydrocarbon deposits. This display also assists in characterizing subsurface features in the area of interest, providing for quick selection of target hydrocarbon deposits or other target subsurface features. The speed and ease of using this display greatly reduces the time it takes to analyze seismic data, which is already a lengthy process. Rather than providing a rough estimate of depth uncertainty, this display greatly improves accuracy of analyzing seismic data and provides personnel with immediate information on important subsurface features.

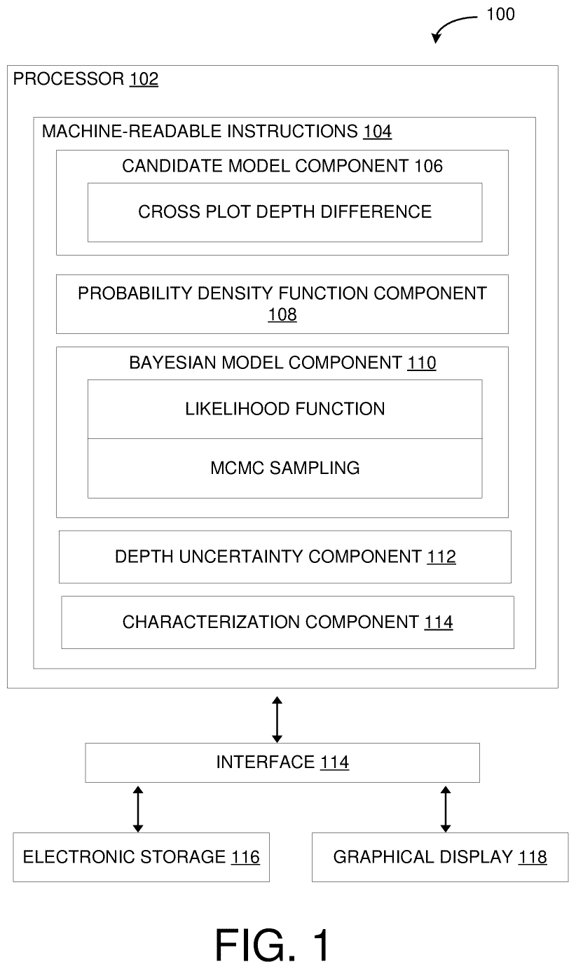

FIG. 1 illustrates an example system 100 incorporating the systems and methods described above. The electronic storage 116 may be configured to include an electronic storage medium that electronically stores information. The electronic storage 116 may store software algorithms, information determined by the processor 102, information received remotely, and/or other information that enables the system 100 to function properly. For example, electronic storage 116 may store information relating to seismic data, and/or other information. The electronic storage media of electronic storage 116 may be provided integrally (i.e., substantially non-removable) with one or more components of the system 100 and/or as removable storage that is connectable to one or more components of the system 100 via, for example, a port (e.g., a USB port, a Firewire port, etc.) or a drive (e.g., a disk drive, etc.). The electronic storage 116 may include one or more of optically readable storage media (e.g., optical disks, etc.), magnetically readable storage media (e.g., magnetic tape, magnetic hard drive, floppy drive, etc.), electrical charge-based storage media (e.g., EPROM, EEPROM, RAM, etc.), solid-state storage media (e.g., flash drive, etc.), and/or other electronically readable storage media. Electronic storage 116 may be a separate component within system 100, or electronic storage 116 may be provided integrally with one or more other components of system 100 (e.g., processor 102). Although electronic storage 116 is shown in FIG. 1 as a single entity, this is for illustrative purposes only. In some implementations, electronic storage 116 may include a plurality of storage units. These storage units may be physically located within the same device, or electronic storage 116 may represent storage functionality of a plurality of devices operating in coordination.

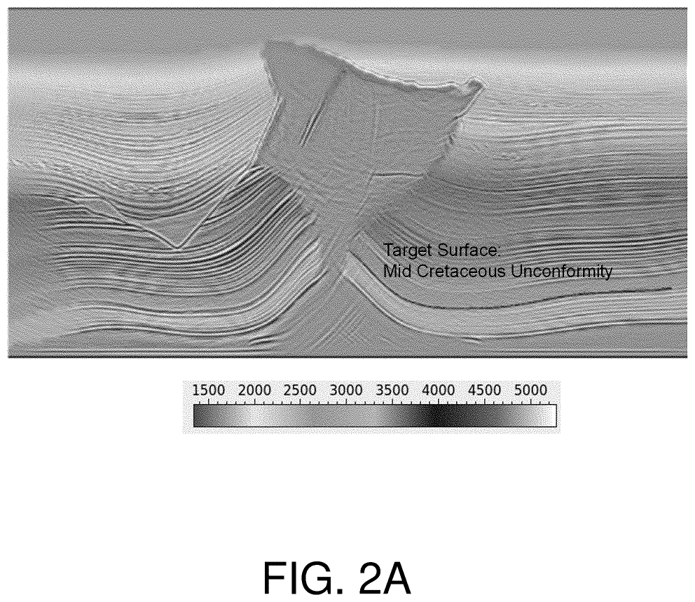

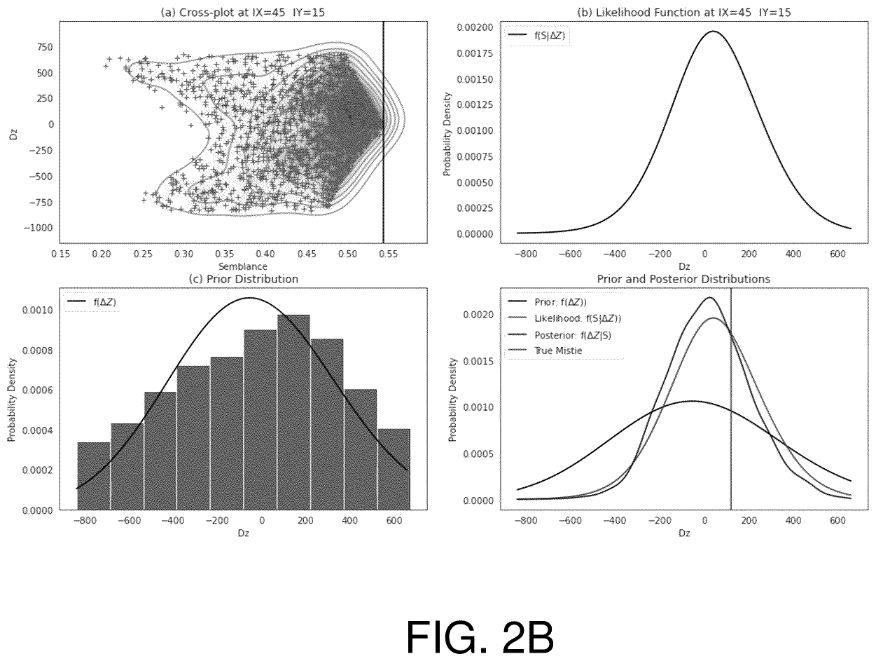

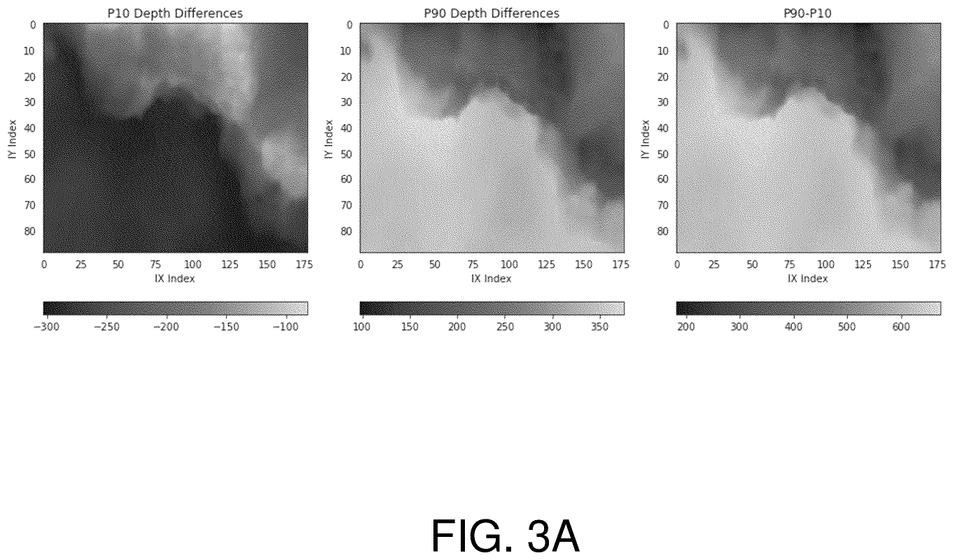

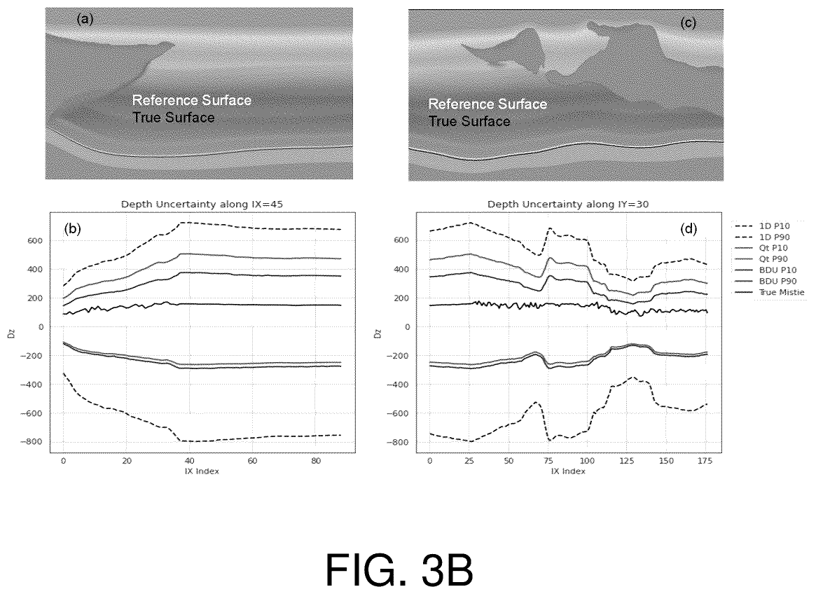

Graphical display 118 may refer to an electronic device that provides visual presentation of information. Graphical display 118 may include a color display and/or a non-color display. Graphical display 118 may be configured to visually present information. Graphical display 118 may present information using/within one or more graphical user interfaces. For example, graphical display 118 may present information relating to seismic data, seismic picks, and/or other information. Graphical display 118 may present information including, but not limited to, graphical representations of depth uncertainty as described below in FIGS. 2A-2B and 3A-3B.

Processor 102 may be configured to provide information processing capabilities in the system 100. As such, processor 102 may include one or more of a digital processor, an analog processor, a digital circuit designed to process information, a central processing unit, a graphics processing unit, a microcontroller, an analog circuit designed to process information, a state machine, and/or other mechanisms for electronically processing information. Processor 102 may be configured to execute one or more machine-readable instructions 104 to facilitate seismic event picking. Machine-readable instructions 104 may include one or more computer program components. Machine-readable instructions 104 may include a candidate model component 106, probability density function component 108, a Bayesian model component 110, a depth uncertainty component 112, a characterization component 114, and/or other computer program components.

It should be appreciated that although computer program components are illustrated in FIG. 1 as being co-located within a single processing unit, one or more of computer program components may be located remotely from the other computer program components. While computer program components are described as performing or being configured to perform operations, computer program components may include instructions which may program processor 102 and/or system 100 to perform the operation.

While computer program components are described herein as being implemented via processor 102 through machine-readable instructions 104, this is merely for ease of reference and is not meant to be limiting. In some implementations, one or more functions of computer program components described herein may be implemented via hardware (e.g., dedicated chip, field-programmable gate array) rather than software. One or more functions of computer program components described herein may be software-implemented, hardware-implemented, or software and hardware-implemented.

Referring again to machine-readable instructions 104, candidate model component 106 can be configured to accept many earth models as input. The earth model can be a 2-D or 3-D representation of the subsurface that includes information about the seismic velocity (P-wave velocity and/or S-wave velocity) and the anisotropic parameters (η and δ) at each location. From these candidate models, a subset can be selected as trial models. Candidate model component 106 can preset a size of moving window for calculating local averages of the residual normal moveouts and use them to select models. The preset value is determined by prior knowledge on the complexity of the geological structures. Typically, a large value should be used where geological structures are simple, and a small value should be used otherwise. This preset can take into account local criterion such as a minimum number of rays. In some embodiments, candidate model component 106 can consider semblances at locations where the total number of rays is less than five as missing data and use geostatistical methods to spatially interpolate values there. This preset can take into account the local variability of residual normal moveouts to allow for a larger total number of trial models. By increasing the number of available trial models, candidate model component 106 can reduce Monte Carlo errors and increase the reliability of the uncertainty estimation. Instead of applying subjective cutoffs to select appropriate models, probability density function component 106 can remove subjectivity based on the local criterion.

The set of all available trial models can be represented by M={mᵢ:i∈N}, where mᵢ is a 3D model consisting of velocity and anisotropic parameters, and N={1, 2, . . . , n} is an index set of the trial models. Probability density function component 108 can define z_{ref} as the depth to the target surface calculated from the reference velocity model, and z(mᵢ) as the depth to the target surface calculated from trial model mᵢ. Probability density function component 108 can calculate the depth difference set as H={z(mᵢ)−z_{ref}:i∈N}. In some embodiments, semblances can be calculated for each trial model using Gaussian beam methods, where G={s(mᵢ):i∈N} can represent the semblance set. The current definitions of H and G represent one target surface, but it should be noted that the systems and embodiments described herein can be applied to multiple target surfaces. The histogram of data H can be fitted to a parametric probability distribution, such as a Gamma distribution, i.e., f(ΔZ)˜Gamma(k, θ). The histogram can also be fitted as a nonparametric probability distribution. The fitted probability distribution function can be treated as a prior function in the Bayesian model component 110. Another part of Probability density function component 108 can fit the pairwise data {H, G} using kernel density estimation to get a joint probability distribution f(S, ΔZ), where S represents the random variable of semblance. This function can be used to derive a likelihood function when an observed seismic semblance becomes available, which can be be used in Bayesian model component 108, together with the prior probability distribution.

The estimated variable is the difference between the true depth (zₜᵣᵤₑ) and the reference depth (z_{ref}) to a surface of interest. Since the true depth in unknown, the difference (ΔZ=zₜᵣᵤₑ−z_{ref}) can be treated as a random variable and the semblance can be calculated from the reference model as data s_{ref}=s(m_{ref}). Given data s_{ref} and f(S, ΔZ), Bayesian model component 110 can be configured to derive the likelihood function f(s_{ref}|ΔZ) given data s_{ref} and the joint distribution from step 2. In particular, the likelihood function, together with the prior probability function derived from the probability density function component f(ΔZ), can define a Bayesian model below, where f(ΔZ|s_{ref}) is the posterior probability distribution function. The symbol C represents a normalizing constant, which does not affect estimation results.

$$f ( Δ Z \vert {s}_{ref} ) = Cf ( {s}_{ref} \vert Δ Z ) f ( Δ Z )$$

In some embodiments, a Markov Chain Monte Carlo (MCMC) sampling method can be applied to draw many samples from the posterior distribution. Bayesian model component 110 can provide a class of algorithms for systematic random sampling from high-dimensional probability distributions. In MCMC sampling, the next sample is dependent on the existing sample, which allows the algorithms to narrow in on the quantity that is being approximated from the distribution, regardless of the number of random variables.

Depth uncertainty component 112 can be configured to draw samples from the posterior distribution f(ΔZ|s_{ref}) using MCMC methods. A subset of these samples can be used to calculate the depth uncertainty. In particular, depth uncertainty component 112 can apply these samples to determine the P10 and P90 values for depth uncertainty.

Characterization component 114 can characterize the subsurface area of interest based on the depth uncertainty. Depth uncertainty estimation is important in risk assessments for hydrocarbon exploration because it helps with economic evaluation of a potential prospect, guides well planning and drilling, and leads to optimal business decisions.

The description of the functionality provided by the different computer program components described herein is for illustrative purposes, and is not intended to be limiting, as any of computer program components may provide more or less functionality than is described. For example, one or more of computer program components may be eliminated, and some or all of its functionality may be provided by other computer program components. As another example, processor 102 may be configured to execute one or more additional computer program components that may perform some or all of the functionality attributed to one or more of computer program components described herein.

FIG. 2A illustrates a velocity model along a profile. In FIG. 2A, Mid Cretaceous Unconformity is the target surface to estimate depth uncertainty. As described above, the velocity model can be a 2-D or 3-D representation of the subsurface that includes information about the seismic velocity (P-wave velocity and/or S-wave velocity) and, optionally, the anisotropic parameters (η and δ) at each location. This velocity model can be used to generate the candidate models. In the example of FIG. 2A, the velocity model includes overburden salt structures above the target surface Mid Cretaceous Unconformity that are complex. This can cause many challenges in deepwater subsalt imaging in tertiary basins. The system of FIG. 1 as described above can address these complexities and produce an accurate depth uncertainty model.

FIG. 2B illustrates an example of the Bayesian model workflow as applied to a location of the velocity model in FIG. 2A. Graph (a) in the top left illustrates a cross-plot of depth differences and semblances calculated from trial models. Graph (c) illustrates the histogram of depth differences from all trial models and the derived prior distribution from trial model data. As described above, the depth differences from the trial models can be fitted to a Gamma distribution, i.e., f(ΔZ)˜Gamma(k, θ). Finally, graph (d) in the bottom right illustrates a comparison between f(ΔZ), f(s_{ref}|ΔZ), and f(ΔZ|s_{ref}), together with the true mistie. The mistie is defined as the difference between the estimated depth to the target surface and the true depth to the surface, which is available only for synthetic study.

FIG. 3A illustrates graphical representations of the P10 and P90 depth uncertainty functions. Both the estimated P10 and P90 of depth differences are spatially variable, and their spatial distributions may not same, depending on the local characteristics of geological structures. FIG. 3B illustrates additional graphical representations of the depth uncertainty. Graphs (a) and (c) illustrate the sampled reference surfaces, and graphs (b) and (d) illustrate the respective depth uncertainty functions. The solid black lines illustrate the true values, and the dashed black lines show the P10 and P90 derived from prior models. The red and blue lines show the P10 and P90 estimated using traditional methods versus the data-driven Bayesian method described in the embodiments and systems herein. As illustrated by graphs (b) and (d), both quantile-based and Bayesian estimates provide good estimates of uncertainty estimation, but Bayesian depth uncertainty is more accurate.

The graphical representations 3A-3B provide results when the workflow given in FIG. 2B is applied to each location of the area of interest. FIG. 3A shows a plane view of the estimates. FIG. 3B compares the estimated depth uncertainties using different methods with the corresponding true misties along two different profiles. The true misties all lie within P10 and P90 depth estimates, and the depth ranges from the proposed methods are more robust and accurate than conventional methods. As described above, these new estimates provide more reliable information for hydrocarbon explorations and production. Therefore, they can lead to significant cost reduction and improve risk managements.

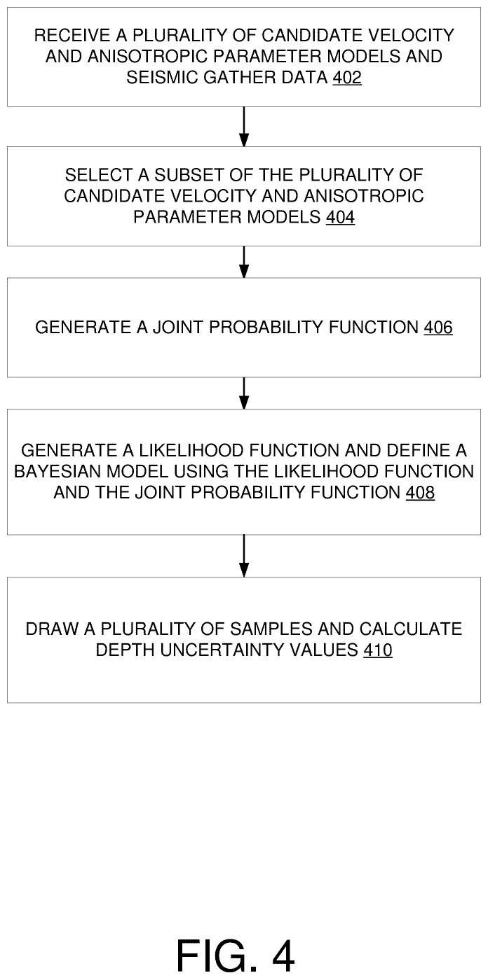

FIG. 4 illustrates an example method in accordance with the embodiments described above. At block 402, the system can receive a plurality of candidate velocity and anisotropic parameter models and seismic gather data. The multiple candidate models can honor the physics of locally 1D medium by satisfying the flatness of the pre-stack seismic traces. As described above, the seismic data can include a 2-D or 3-D representation of the subsurface that includes information about the seismic velocity (P-wave velocity and/or S-wave velocity) and, optionally, the anisotropic parameters (η and δ) at each location. The system can randomly perturb to produce a plurality of candidate or trial models, which include both P-wave velocity and anisotropic parameters. For each trial model, the system calculates depth differences and seismic semblance values.

At block 404, the system can select a subset of the plurality of candidate velocity and anisotropic parameter models to form a training data set. The system can calculate residual normal moveout and set a window size based on the residual normal moveout. A cutoff value can be specified based on the residual normal moveout and the window size. At block 406, the system can generate a joint probability function of depth differences and seismic semblances based on the training data set. The set of all available trial models can be represented by M={mᵢ:i∈N}, where mᵢ is a 3D model consisting of velocity and anisotropic parameters, and N={1, 2, . . . , n} is an index set of the trial models. z_{ref} can be defined as the depth to the target surface calculated from the reference velocity model, and z(mᵢ) can be defined as the depth to the target surface calculated from trial model mᵢ. The resulting depth difference set can be defined as H={z(mᵢ)−z_{ref}:i∈N}. The difference (ΔZ=zₜᵣᵤₑ−z_{ref}) can be treated as a random variable and the semblance calculated from the reference model can be treated as data s_{ref}=s(m_{ref}). Similarly, semblances can also be calculated for each trial model using Gaussian beam methods, and their results can be represented as set G={s(mᵢ):i∈N}. The depth differences and the semblances can fit with a nonparametric function using kernel density estimation to get a joint probability distribution f(S, ΔZ), where S represents the random variable of semblance. Gamma distribution or any nonparametric probability such as machine learning methods can be employed to fit depth differences to get prior probability distribution.

At block 408, the system can generate a likelihood function and define a Bayesian model based on the probability density function by using the likelihoods of depth differences given the reference semblance data and prior distributions of the depth differences. The Bayesian model can be represented as:

$$f ( Δ Z \vert {s}_{ref} ) = Cf ( {s}_{ref} \vert Δ Z ) f ( Δ Z )$$

Letter C can represent a normalizing constant, which does not affect estimation results if MCMC sampling is used. Function f(ΔZ) can represent the prior distribution of unknown depth difference, which is derived from the depth difference set H of the trial models. The combination of semblances and the depth differences from the trial models (H, G) provide information on the joint distribution of this variable (ΔZ). These Bayesian models can successfully provide robust and better estimates of depth uncertainty.

At block 410, the system can estimate depth uncertainty by drawing many samples from the posterior distribution using Markov Chain Monte Carlo sampling techniques. After using some proper convergence measures, the MCMC process is deemed to converge. The latter half of those samples can be used to calculate the depth uncertainty in the form of the 10^{th} and 90^{th} quantiles.

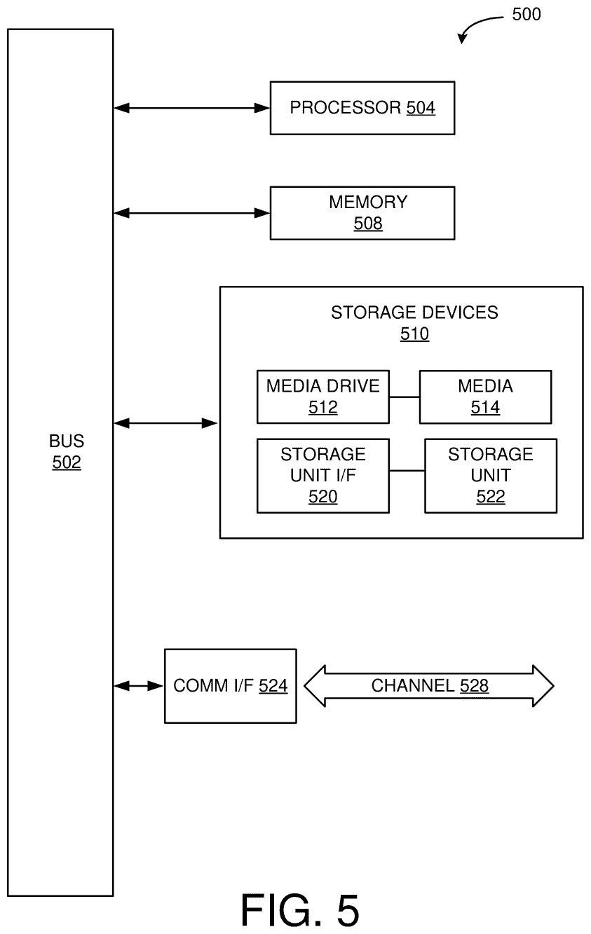

As used herein, the terms circuit and component might describe a given unit of functionality that can be performed in accordance with one or more embodiments of the present application. As used herein, a component might be implemented utilizing any form of hardware, software, or a combination thereof. For example, one or more processors, controllers, ASICs, PLAS, PALs, CPLDs, FPGAs, logical components, software routines or other mechanisms might be implemented to make up a component. Various components described herein may be implemented as discrete components or described functions and features can be shared in part or in total among one or more components. In other words, as would be apparent to one of ordinary skill in the art after reading this description, the various features and functionality described herein may be implemented in any given application. They can be implemented in one or more separate or shared components in various combinations and permutations. Although various features or functional elements may be individually described or claimed as separate components, it should be understood that these features/functionalities can be shared among one or more common software and hardware elements. Such a description shall not require or imply that separate hardware or software components are used to implement such features or functionality.

Where components are implemented in whole or in part using software, these software elements can be implemented to operate with a computing or processing component capable of carrying out the functionality described with respect thereto. One such example computing component is shown in FIG. 5. Various embodiments are described in terms of this example-computing component 500. After reading this description, it will become apparent to a person skilled in the relevant art how to implement the application using other computing components or architectures.

Referring now to FIG. 5, computing component 500 may represent, for example, computing or processing capabilities found within a self-adjusting display, desktop, laptop, notebook, and tablet computers. They may be found in hand-held computing devices (tablets, PDA's, smart phones, cell phones, palmtops, etc.). They may be found in workstations or other devices with displays, servers, or any other type of special-purpose or general-purpose computing devices as may be desirable or appropriate for a given application or environment. Computing component 500 might also represent computing capabilities embedded within or otherwise available to a given device. For example, a computing component might be found in other electronic devices such as, for example, portable computing devices, and other electronic devices that might include some form of processing capability.

Computing component 500 might include, for example, one or more processors, controllers, control components, or other processing devices. Processor 504 might be implemented using a general-purpose or special-purpose processing engine such as, for example, a microprocessor, controller, or other control logic. Processor 504 may be connected to a bus 502. However, any communication medium can be used to facilitate interaction with other components of computing component 500 or to communicate externally.

Computing component 500 might also include one or more memory components, simply referred to herein as main memory 508. For example, random access memory (RAM) or other dynamic memory, might be used for storing information and instructions to be executed by processor 504. Main memory 508 might also be used for storing temporary variables or other intermediate information during execution of instructions to be executed by processor 504. Computing component 500 might likewise include a read only memory (“ROM”) or other static storage device coupled to bus 502 for storing static information and instructions for processor 504.

The computing component 500 might also include one or more various forms of information storage mechanism 510, which might include, for example, a media drive 512 and a storage unit interface 520. The media drive 512 might include a drive or other mechanism to support fixed or removable storage media 514. For example, a hard disk drive, a solid-state drive, a magnetic tape drive, an optical drive, a compact disc (CD) or digital video disc (DVD) drive (R or RW), or other removable or fixed media drive might be provided. Storage media 514 might include, for example, a hard disk, an integrated circuit assembly, magnetic tape, cartridge, optical disk, a CD or DVD. Storage media 514 may be any other fixed or removable medium that is read by, written to or accessed by media drive 512. As these examples illustrate, the storage media 514 can include a computer usable storage medium having stored therein computer software or data.

In alternative embodiments, information storage mechanism 510 might include other similar instrumentalities for allowing computer programs or other instructions or data to be loaded into computing component 500. Such instrumentalities might include, for example, a fixed or removable storage unit 522 and an interface 520. Examples of such storage units 522 and interfaces 520 can include a program cartridge and cartridge interface, a removable memory (for example, a flash memory or other removable memory component) and memory slot. Other examples may include a PCMCIA slot and card, and other fixed or removable storage units 522 and interfaces 520 that allow software and data to be transferred from storage unit 522 to computing component 500.

Computing component 500 might also include a communications interface 524. Communications interface 524 might be used to allow software and data to be transferred between computing component 500 and external devices. Examples of communications interface 524 might include a modem or softmodem, a network interface (such as Ethernet, network interface card, IEEE 802.XX or another interface). Other examples include a communications port (such as for example, a USB port, IR port, RS232 port Bluetooth® interface, or other port), or another communications interface. Software/data transferred via communications interface 524 may be carried on signals, which can be electronic, electromagnetic (which includes optical) or other signals capable of being exchanged by a given communications interface 524. These signals might be provided to communications interface 524 via a channel 528. Channel 528 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media. Such media may be, e.g., memory 508, storage unit 520, media 514, and channel 528. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing component 500 to perform features or functions of the present application as discussed herein.

It should be understood that the various features, aspects and functionality described in one or more of the individual embodiments are not limited in their applicability to the particular embodiment with which they are described. Instead, they can be applied, alone or in various combinations, to one or more other embodiments, whether or not such embodiments are described and whether or not such features are presented as being a part of a described embodiment. Thus, the breadth and scope of the present application should not be limited by any of the above-described exemplary embodiments.

Terms and phrases used in this document, and variations thereof, unless otherwise expressly stated, should be construed as open ended as opposed to limiting. As examples of the foregoing, the term “including” should be read as meaning “including, without limitation” or the like. The term “example” is used to provide exemplary instances of the item in discussion, not an exhaustive or limiting list thereof. The terms “a” or “an” should be read as meaning “at least one,” “one or more” or the like; and adjectives such as “conventional,” “traditional,” “normal,” “standard,” “known.” Terms of similar meaning should not be construed as limiting the item described to a given time period or to an item available as of a given time. Instead, they should be read to encompass conventional, traditional, normal, or standard technologies that may be available or known now or at any time in the future. Where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “component” does not imply that the aspects or functionality described or claimed as part of the component are all configured in a common package. Indeed, any or all of the various aspects of a component, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A computer-implemented method for subsurface characterization from seismic gather data, the method comprising:
receiving a plurality of candidate velocity and anisotropic parameter models;
receiving the seismic gather data;
selecting a subset of the plurality of candidate velocity and anisotropic parameter models to form a training data set;
generating a joint probability function of depth differences and seismic semblances based on the training data set;
generating a likelihood function based on the joint probability function;
defining a Bayesian model using the likelihood function and prior probability functions; and
drawing a plurality of samples from a posterior distribution of the Bayesian model using Markov Chain Monte Carlo sampling and calculating depth uncertainty values using the plurality of samples.

2. The computer-implemented method of claim 1, wherein selecting the subset of the plurality of candidate velocity and anisotropic parameter models comprises:
calculating residual normal moveout;
setting a window size based on the residual normal moveout; and
specifying a cutoff value based on the residual normal moveout and the window size.

3. The computer-implemented method of claim 1, wherein the seismic gather related data includes semblances, numbers of rays, and a minimal and maximal variance for calculating semblances.

4. The computer-implemented method of claim 1, wherein generating the joint probability function of depth differences and seismic semblances comprises employing Kernal density estimation.

5. The computer-implemented method of claim 1, wherein the joint probability function of depth differences is based on a difference between true depth (zₜᵣᵤₑ) and reference depth (z_{ref}).

6. The computer-implemented method of claim 1, wherein the samples are obtained using Markov Chain Monte Carlo sampling.

7. The computer-implemented method of claim 1, wherein the depth uncertainty values are measured by 10^{th} and 90^{th} quantiles of half of the plurality of samples.

8. The computer-implemented method of claim 1, further comprising:
generating a graphical representation of the depth uncertainty values based on corresponding depth;
displaying the graphical representation of the depth uncertainty values on a user interface; and
characterizing a subsurface area of interest based on the graphical representation.

9. A system for subsurface characterization from seismic gather data comprising:
a processor;
a display; and
a memory encoded with instructions, which when executed by the processor, cause the processor to:
receive a plurality of candidate velocity and anisotropic parameter models;
receive the seismic gather data;
select a subset of the plurality of candidate velocity and anisotropic parameter models to form a training data set;
generate a joint probability function of depth differences and seismic semblances based on the training data set;
generate a likelihood function based on the joint probability function;
define a Bayesian model using the likelihood function and the joint probability function;
draw a plurality of samples from a posterior distribution of the Bayesian model using Markov Chain Monte Carlo sampling and calculate depth uncertainty values using the plurality of samples;
generate a graphical representation of the depth uncertainty values based on corresponding depth;
display the graphical representation of the depth uncertainty values on a user interface; and
characterize a subsurface area of interest based on the graphical representation.

10. The system of claim 9, wherein selecting the subset of the plurality of candidate velocity and anisotropic parameter models comprises:
calculating residual normal moveout;
setting a window size based on the residual normal moveout; and
specifying a cutoff value based on the residual normal moveout and the window size.

11. The system of claim 9, wherein the seismic gather related data includes semblances, a number of rays, and a minimal and maximal variance for calculating semblances.

12. The system of claim 9, wherein generating the joint probability function of depth differences and seismic semblances comprises employing Kernal density estimation.

13. The system of claim 9, wherein the joint probability function of depth differences is based on a difference between true depth (zₜᵣᵤₑ) and reference depth (z_{ref}).

14. The system of claim 9, wherein the samples are obtained using Markov Chain Monte Carlo sampling.

15. The system of claim 9, wherein the depth uncertainty values are measured by 10^{th} and 90^{th} quantiles of half of the plurality of samples.

16. A non-transitory machine-readable storage medium encoded with instructions, which, when executed by a processor, cause the processor to:
receive a plurality of candidate velocity and anisotropic parameter models;
receive seismic gather data;
select a subset of the plurality of candidate velocity and anisotropic parameter models to form a training data set;
generate a joint probability function of depth differences and seismic semblances based on the training data set;
generate a likelihood function based on the joint probability function;
define a Bayesian model using the likelihood function and the joint probability function;
draw a plurality of samples from a posterior distribution of the Bayesian model using Markov Chain Monte Carlo sampling and calculate depth uncertainty values using the plurality of samples;
generate a graphical representation of the depth uncertainty values based on corresponding depth;
display the graphical representation of the depth uncertainty values on a user interface; and
characterize a subsurface area of interest based on the graphical representation.

17. The non-transitory machine-readable storage medium of claim 16, wherein selecting the subset of the plurality of candidate velocity and anisotropic parameter models comprises:
calculating residual normal moveout;
setting a window size based on the residual normal moveout; and
specifying a cutoff value based on the residual normal moveout and the window size.

18. The non-transitory machine-readable storage medium of claim 16, wherein the seismic gather data includes semblances, a number of rays, and a minimal and maximal variance for calculating semblances.

19. The non-transitory machine-readable storage medium of claim 16, wherein generating the joint probability function of depth differences and seismic semblances comprises employing Kernal density estimation.

20. The non-transitory machine-readable storage medium of claim 16, wherein the joint probability function of depth differences is based on a difference between true depth (zₜᵣᵤₑ) and reference depth (z_{ref}).
